(19) United States
(12) Patent Application Publication
(10) Pub. No.: US 2014/0279063 A1
(43) Pub. Date: Sep. 18, 2014

(54) METHOD & APPARATUS HAVING VIRTUAL ENVIRONMENT FOR DISPLAY & SELECTION OF MARKETING MATERIALS TO CREATE CUSTOMIZED MARKETING KIT & ASSIST PLACEMENT OF MARKETING MATERIALS

(71) Applicant: Barkley, Inc., Kansas City, MO (US)

(72) Inventors: Shawn R. POLOWNIAK, Olathe, KS (US); Dana L. NOLTE, Olathe, KS (US)

(73) Assignee: BARKLEY, INC., Kansas city, MO (US)

(21) Appl. No.: 14/213,915

(22) Filed: Mar. 14, 2014

Related U.S. Application Data
(60) Provisional application No. 61/782,175, filed on Mar. 14, 2013.

(51) Int. Cl. G06Q 30/02; G06Q 10/06

(52) U.S. Cl. CPC G06Q 30/0276; G06Q 10/067
USPC 705/14.72; 705/348

(57) ABSTRACT

A consumer experience modeling system and method includes input of an analysis of a consumer experience into a brand analysis. Consumer analysis includes data from one or more consumer experiences with a consumer environment. Brand analysis includes the input of data from the consumer analysis, and a system and method of modeling the consumer environment. The consumer experience modeling system and method allows an operator to interact with a virtual consumer environment, the key zones of the environment, and the markers therein. The operator can modify the existing markers in the virtual consumer environment, and can create and place new markers therein. The markers can be selected, edited, manufactured, and distributed to an operator's retail consumer environment. Upon receipt of the markers, an operator can access the system to properly implement the markers in the consumer environment. The system interfaces with complimentary marker ordering, printing, and product development software.

### CROSS-REFERENCE TO RELATED APPLICATION

This application claims the benefit of U.S. Provisional Application No. 61/782,175, filed Mar. 14, 2013, the contents of which are incorporated herein by reference.

### BACKGROUND

1. Field of the Disclosed Subject Matter

The present disclosed subject matter relates generally to a system and method of modeling a consumer experience, and more particularly to a system and method of assisting an individual with designing, selecting, and positioning markers in a consumer environment to influence consumer purchasing behavior.

2. Background

Consumer environments, including the retail facility of a business, use markers to influence a consumer's experience and purchasing behavior. Visual markers include the physical layout of the exterior and interior of the retail facility, fixtures, furnishings, colors, lighting, style of dress, signage, advertising materials, sales materials, menus, etc. In addition, the sounds, smells, and temperature of the consumer environment can influence a consumer's experience and purchasing decisions. A consumer's experience with the markers of a retail facility influence a consumer's perception of the business' brand, and influence the consumers' purchasing behavior. Thus the selection, arrangement, and location of visual and non-visual markers are important for the success of a business.

Franchisors of business concepts provide operators of business franchises with standardized markers for use in their retail business. Operators are presented with a listing of standardized visual markers, including signage, advertising materials, sales materials, menus, and other textual and graphical materials, and their proper use, and select some of the markers from a list to deploy in their retail business. The markers are subsequently delivered to the operator, and the operator must remember what markers to use where and how. For example, a number of existing markers in use at a location of the retail business may be consistent or inconsistent with the newly selected and delivered markers. Further, improper placement may lead to overcrowding of table tops, bars and other surface areas. Improper selection, arrangement, and use of markers in the retail environment can confuse the consumer and have an adverse influence on a consumer's perception of the business' brand, and an adverse influence on the consumers' purchasing behavior. Moreover, inconsistent selection, arrangement, and use of markers across franchisees have an adverse influence upon the business' brand.

It is desirable to assess and communicate the selection, arrangement, and location of visual and non-visual markers that are successful in conveying a brand to a consumer so such markers can be used throughout businesses' consumer-facing environments in a consistent manner. The development and implementation of effective visual and non-visual markers throughout a consumer-facing environment is at a great expense to the business and brand. It is difficult for a business to decide what visual markers to use. Businesses frequently select visual markers to use that are not effectively implemented in the consumer-facing environment, or are not used at all. Businesses struggle with a process for standardizing the development, selection, manufacture, and distribution of visual markers to best communicate their brand.

Heretofore, there has not been available a consumer experience modeling method with advantages and features of the disclosed subject matter.

### SUMMARY

In general, in an aspect, the disclosed subject matter can be implemented to include receiving information representing a consumer environment, receiving information representing at least one marker of the consumer environment, and displaying the consumer environment and at least one marker on a display.

The disclosed subject matter also can be implemented such that the information representing the consumer environment includes at least one key zone. Further, the subject matter can be implemented to include at least one key zone identified by a consumer.

The disclosed subject matter also can be implemented such that displaying of the consumer environment includes displaying an interactive virtual representation of the consumer environment. Further, the subject matter can be implemented wherein the virtual representation includes at least one key zone, and the display of at least one marker that includes text and graphics. The subject matter can be implemented to include preparing a new marker including text and graphics, importing the new marker into the interactive virtual representation, and displaying the new marker on the display.

The disclosed subject matter also can be implemented to select at least one marker, modify the at least one marker, add and remove text and graphics, and move the marker. Further, the subject matter can be implemented such that a marker can be selected for manufacture and distribution to a consumer environment.

In general, in another aspect, the subject matter can be implemented as a computer program product, encoded on a computer-readable medium, operable to cause a data processing apparatus to perform operations comprising receiving data representing a consumer environment, receiving data representing at least one marker of the consumer environment, and displaying the consumer environment and the at least one marker on a display.

The disclosed subject matter also can be implemented such that the information representing the consumer environment includes at least one key zone. Further, the subject matter can be implemented to include at least one key zone identified by a consumer.

The disclosed subject matter also can be implemented such that displaying of the consumer environment includes displaying an interactive virtual representation of the consumer environment. Further, the subject matter can be implemented wherein the virtual representation includes at least one key zone, and the display of at least one marker that includes text and graphics. The subject matter can also be implemented to be further operable to cause the data processing apparatus to perform operations comprising preparing a new marker including text and graphics, importing the new marker into the interactive virtual representation, and displaying the new marker on the display.

The disclosed subject matter can also be implemented to be further operable to cause the data processing apparatus to perform operations comprising selecting at least one marker, modifying the at least one marker, adding and removing text and graphics, and moving the marker. Further, the subject matter can also be implemented to be further operable to cause the data processing apparatus to perform operations comprising selecting a marker for manufacture and distributing a marker to a consumer environment.

In general, in another aspect, the subject matter can be implemented such that a data processing device receives data representing a consumer environment, receives data representing at least one marker of the consumer environment, and displays the consumer environment and the at least one marker on a display.

The disclosed subject matter also can be implemented such that the information representing the consumer environment includes at least one key zone. Further, the subject matter can be implemented to include at least one key zone identified by a consumer.

The disclosed subject matter also can be implemented such that the data processing device displays an interactive virtual representation of the consumer environment. Further, the subject matter can be implemented wherein the virtual representation includes at least one key zone, and the display of at least one marker that includes text and graphics. The subject matter can also be implemented such that the data processing device prepares a new marker including text and graphics, imports the new marker into the interactive virtual representation, and displays the new marker on the display.

The disclosed subject matter can also be implemented such that the data processing device selects at least one marker, modifies the at least one marker, adds and removes text and graphics, and moves the marker. Further, the subject matter can also be selects a marker for manufacture and distributes the marker to a consumer environment.

In general, in an aspect, the disclosed subject matter can be implemented to include conducing a brand overview, selecting a target consumer environment, selecting a consumer to experience the target consumer environment, developing a consumer query to document the consumer experience with the target consumer environment, visiting the target consumer environment by the consumer, and gathering the consumer response to the consumer query.

The disclosed subject matter can also be implemented to include selecting a plurality of consumers to experience the target consumer environment, and summarizing the consumer responses to the consumer quires. Further, the subject matter can be implemented to include presenting the consumer query to the consumer prior to the consumer visiting the target consumer environment.

The disclosed subject matter also can be implemented such that the target consumer environment includes at least one key zone, wherein a key zone includes the exterior of a physical space, and entrance, a space devoted to the sale of goods and services, a food service area, a payment area, and a restroom. Further, the subject matter can be implemented wherein the consumer query includes at least one query seeking the consumer experience with the at least one key zone, and wherein the consumer query includes at least one query seeking the consumer experience with the at least one marker.

The disclosed subject matter also can be implemented such that the target consumer environment includes at least one marker, wherein a marker includes a fixture, a furnishing, a color, a lighting, a style of dress, a sign, an advertising material, a sales material, a menu, a sound, a smell, and a temperature. Further, the subject matter can be implemented wherein the consumer response to the consumer query identifies a key zone of the consumer experience.

In general, in an aspect, the disclosed subject matter can be implemented such that an operator selects a marketing kit in a virtual representation of a consumer environment for manufacture and delivery.

### BRIEF DESCRIPTION OF THE DRAWINGS

The drawings constitute a part of this specification and include exemplary embodiments of the disclosed subject matter and illustrate various objects and features thereof.

FIG. 1 is a flow chart illustrating a method of consumer analysis according to an embodiment of the disclosed subject matter.

FIG. 2 shows a block diagram of an embodiment of the underlying architecture of the disclosed subject matter.

FIG. 3 shows a block diagram of an embodiment of a database of the disclosed subject matter.

FIG. 4 shows a user interface according to an embodiment of the disclosed subject matter.

FIG. 5 shows another user interface according to an embodiment of the disclosed subject matter.

FIG. 6 shows another user interface according to an embodiment of the disclosed subject matter.

### DETAILED DESCRIPTION

Detailed aspects of the disclosed subject matter are disclosed herein; however, it is to be understood that the disclosed aspects are merely exemplary of the disclosed subject matter, which may be embodied in various forms. Therefore, specific structural and functional details disclosed herein are not to be interpreted as limiting, but merely as a basis for the claims and as a representative basis for teaching one skilled in the art how to variously employ the disclosed technology in virtually any appropriately detailed structure.

Referring to the following disclosure, a consumer experience modeling system and method is shown and described. An embodiment of the modeling system and method includes the input of an analysis of a consumer experience into a brand analysis. The consumer analysis includes data from one or more consumer experiences with a consumer environment. The brand analysis includes the input of data from the consumer analysis, and a system and method of modeling the consumer environment using the data from one or more consumer experiences to determine the design, selection, and positioning of markers in a consumer environment to best represent the business' brand, and influence consumer purchasing behavior. The system and method of modeling the consumer environment allows an operator to design, select, order, ship, and deploy markers to their consumer environment, and instruction for proper implementation of the markers.

In an embodiment, the function of consumer analysis is to assess consumers' experience with a brand in the brand's consumer environment to determine the effectiveness of a brand at a particular point in time, and to assess the effectiveness of the brand markers. FIG. 1 is a flow chart illustrating an aspect of the disclosed subject matter, namely a method of providing a consumer analysis 102 by obtaining consumers' experiences with a consumer environment. Consumer analysis 102 begins with a brand overview 104. The brand overview 104 includes identification of information regarding the brand vision, core brand attributes, key selling propositions, competition, and audiences. The brand overview 104 provides a base level of brand overview data 304 that may be stored electronically to aid in location identification 106.

Location identification 106 involves the selection of a target consumer environment that best represents the most common environment in which a consumer experiences the brand. The target consumer environment may be a physical space offering goods or services, such as a restaurant, or an electronic space such as an electronic commerce portal including an internet website or a virtual reality environment.

The target consumer environment includes markers that influence a consumer's experience and purchasing behavior, and how the target consumer experiences the brand. Visual markers include the physical layout of the exterior and interior of a retail facility, fixtures, furnishings, colors, lighting, style of employee dress, signage, advertising materials, sales materials, menus, etc. In addition, other markers include sounds, smells, and temperature. Location identification 106 includes the determination of the geographic location of the target consumer environment, the physical layout of the target consumer environment, and types of brand experiences available in the target consumer environment. The information related to location identification 106 provides a base level of location identification data 306 that may be stored electronically.

Next, the identification of participants 108 involves the selection of participants that best represent the key target audience of the brand. The number of participants varies based on the number of key target audiences. The selected participants will be exposed to the target consumer environment and markers, and provide selected participant data 308 in the form of their experience with the brand in the consumer environment. Selected participant data 308 may be stored electronically, and includes participant demographic information, responses to oral questions, and responses to written questionnaires. The selected participants include biased participants and unbiased participants. Biased participants are exposed to the questions or questionnaire prior to, and subsequent to, their experience with the target consumer environment. Unbiased participants are exposed to the questions or questionnaire only after their experience with the target consumer environment. Generating selected participant data 308 from selected participants in response to both biased and unbiased experiences with the target consumer environment provides insight into the consumer experience based on different levels of consumer attention to their environment, and allows for a comparison of such selected participants.

Next, development of a selected participant's questionnaire 110 is undertaken to document the selected participants' experience with the brand in the consumer environment. The participant questionnaire 110 includes questionnaire data 310 that may be stored electronically, comprising oral and written questions seeking: selected participants' first impression of the consumer environment; selected participants' experience with any advertisements or promotions in the consumer environment; positive impressions the consumer environment left upon the selected participants; negative impressions the consumer environment left upon the selected participants; any key engagements experienced by the selected participants in the consumer environment, and the effect of such engagements; any memorable experiences experienced by the selected participants in the consumer environment, and the effect of such experiences; if the consumer environment had an impact upon the purchasing decisions made by the selected participants, and why; are there any areas that the brand could improve the selected participants overall consumer experience, and how; and any comments by the selected participants regarding their observations throughout their entire experience with the consumer environment including, interactions with people, the environment, promotions, etc.

The participant visit to a location 112 involves the selected participants' interaction with the target consumer environment. The selected participants experience the target consumer environment in a way that is natural for them, and the selected participants are chosen based on their inclination to make purchases so the participant visit is as natural as possible. In an embodiment the target consumer environment is a physical space, and the selected participants search for, select, and purchase goods and services. For example, if the target consumer environment is a retail environment, the selected participants will shop; if the target consumer environment is a restaurant, the selected participants will dine. In another embodiment the consumer environment is an electronic commerce portal, including an Internet website, and the selected participants search for, select, and purchase goods and services. Biased participants will be more acutely aware of their observations because they were exposed to the questions or questionnaire prior to their interaction with the target consumer environment. After the selected participants' have interacted with the target consumer environment they answer questions or complete the participant questionnaire 114. Experience data 314 includes selected participants' responses to the questionnaire data including answers and narratives. The experience data 314 may be stored in an electronic format, and is compiled into a summary report 116 creating summary report data 316, that may be stored electronically.

The summary report data 316 aids in identifying the key zones of the target consumer environment and the markers or points of experience within each of the key zones that influence consumer purchasing behavior. Thus, the key zones are the areas of the target consumer environment that, when combined, create an overall brand experience for the selected participant. Key zones include the consumer-facing spaces of a retail facility or a website. Examples of key zones for a physical space include the exterior of the physical space, the entrance, the space devoted to the sale of goods and services, the food service area, the payment area, and the restrooms. Identification of the key zones through the consumer analysis 102 allows for the identification and development of the overall objectives for a business brand in each key zone, and in the business' consumer environment. The overall objectives are influenced by the strategic objectives of the business, the business objectives of the business, and consumer perspectives of the business and brand.

Within each key zone are markers or points of experience that deliver the overall brand experience to the consumer. When strategically considered and leveraged, markers influence the consumer's experience in the key zones and thus their overall experience with the business and brand. For example, in a physical restaurant, markers include menus, signage, sales materials, fixtures, furnishings, music, uniforms, and people. Markers that have a notable impact upon the consumer are identified, and objectives developed for the markers that can be influenced through marketing. The strategic objectives of the brand, the business objectives of the brand, and consumer perspectives of the brand are specific to each key zone and clearly articulate the purpose of each key zone as well as how it ties back into the overall brand experience. In addition, the objectives of each marker are specific to each marker and clearly articulate the purpose of each marker as well as how it ties back into the overall brand experience. The objectives of each marker identify the proper implementation of each marker.

Modeling the key zones and markers provides a stronger understanding of how to maximize the brand in each consumer environment, and how to best implement the brand through the design, selection, and positioning of markers in a consumer environment to influence the consumer experience and consumer purchasing behavior.

Mapping and modeling a consumer's journey through a business' consumer experience aids in the understanding of a consumer's experience with a brand. Modeling the consumer journey provides a framework for identifying opportunities to maximize the emotional connection with the consumer at each point in the brand experience leading to an increased return on experience (ROE) and increased purchasing behavior.

Consumer experience modeling provides businesses key insights into their consumers' experience with their brand, and provides businesses with tools to help standardize brand implementation and effectiveness, and create consistency at the consumer experience level.

FIG. 2 is a block diagram illustrating an embodiment of the underlying architecture of the disclosed subject matter. A consumer experience modeling system 202 generally includes a computer generated model of a consumer experience environment and the markers in the consumer experience. Operation of the system 202 may be controlled by a processor 204 that executes an operating system, programs, and any other functions of the system 202 including processing data signals received from input devices 206 and communicating data signals to output devices 208. The system 202 may include one or more databases 232 for storing or transferring data and instructions between components of the system 202, including a consumer analysis database 302, and a brand database 352 (FIG. 3).

The processor 204 may comprise a single processor or a plurality of processors such as any conventional processor device known in the art, including other processors that enable various functions of the system 202 such as user interface 400 functions, input devices 206, and output devices 208.

Data, information, and instructions processed by the processor 204 may be stored within the program memory 210. Program memory 210 may include non-volatile memory such as a dynamic storage device, random-access memory (RAM) 212, read-only memory (ROM) 214, flash memory, a hard drive, or any other suitable non-transitory computer-readable memory such as optical, magnetic, or solid-state computer readable media, as well as a combination thereof. A non-transitory computer-readable storage device 216, including a magnetic disk, optical disk, magneto-optical disk, or non-volatile memory may be connected to the processor 204 for storing data, information, and instructions. The terms “memory,” “computer readable medium,” and “computer readable media” can be used interchangeably to mean storage that can be accessed by a computer. These terms include temporary transitory storage (such as data caches used by web browsers, streaming media players and digital video recorders), provided that neither term is intended to include any propagated signal, any carrier wave or any other non-statutory subject matter.

The system 202 may be powered by a suitable power source 218 that may include one or more batteries or an AC power source, such as provided by an electrical outlet.

A user may input data, information, and instructions into the system 202 using an input device 206 including: alphanumeric and other keys; a cursor control, such as a mouse, trackball, or cursor direction keys; and any number of input structures existing in various forms including sensors, buttons, switches, control pad, knob, wheel, or other suitable forms.

System 202 information and images are presented by a display 220. For example, the display 220 may show a user interface 400, described in more detail below. The display 220 may be any type of display, such as a cathode ray tube (CRT), a liquid crystal display (LCD), a light emitting diode (LED) display, and organic light emitting diode (OLED) display, or other suitable display. The display 220 may include touch-sensitive functionality, such as a touch screen. The display 220 may display a graphical user interface that allows a user to interact with the system 202. The graphical user interface may include various screens, layers, windows, images, elements, or components that may be displayed in whole or in part on all or a portion of the display 220.

One or more communication interfaces 222 may provide additional data channels for receiving and transmitting data, information, or instructions. The communication interface 222 may include one or more network interface hardware elements and associated communication protocols. The communication interface 222 provides two-way data communication by a network connection 226 connected to a network 224. The communication interface 222 may include several types of interfaces, including a wireless carrier interface, a wireless local area network (WLAN) interface, and unstructured supplementary service data (USDD) interface, a personal area network (PAN) interface, a local area network (LAN) interface, and a wide area network (WAN) interface. The system 202 may execute one or more sequences of one or more instructions or user data contained in one or more databases 232 connected to the network 224. The network 224 felicitates communication between the modeling system 202 and any other local or remote computers, including third party devices 234, including databases, servers, or web servers. The network 224 can be all or a portion of a distributed or secure network, or a wireless or wired network.

Referring to FIGS. 4-6, an exemplary embodiment of the consumer experience modeling system 202 for a target consumer environment is shown and described, by way of example, a restaurant retail establishment.

The modeling system 202 is presented on a user interface 400, and is viewed by an operator on a display 220 of a data processing device 380, allowing the operator to interact with a virtual model of a consumer experience. The virtual model may be a series of interactive images of the key zones, or may be an interactive animation whereby the operator is presented with the key zones and markers as they navigate through the consumer environment. The operator includes an employee of the business such as a manager of a target consumer environment. Other operators include particular disciplines within the business, such as marketing, human resources, and sales. The user interface 400 allows the operator to experience the represented brand, and select, view, design, and position markers in a virtual consumer environment. The user interface 400 can be implemented in a data processing device 380, including a personal computer, a networked computer, a handheld computer, a personal digital assistant, a cellular telephone, a mobile telephone, a smart telephone, or a combination of any such data processing devices.

The user interface 400 includes textual material 384 and one or more graphical user interfaces 386 and provides the operator access to the various system objects, and for conveying information to the operator. General textual and graphical information for the system 202 is populated with the information from consumer environment data 354. Textual and graphical information specific to the target consumer environment is populated with information from target consumer environment data 356. In an implementation, the graphical user interfaces 386 includes tabs for navigating to different virtual representations of the key zones of the target consumer environment, including a home screen 408 tab, an outside 410 tab, a lobby 412 tab, a main dining 414 tab, a bar 416 tab, a to go 418 tab, and a restroom 420 tab. In an implementation, the home screen 408 tab displays a home screen 402. The home screen 402 includes textual material 384 listing the key zones 406 of the restaurant, including the exterior or outside of the restaurant, the lobby, the main dining area, the bar area, the to go area, and the restrooms. In an implementation, the home screen 402 displays a graphical user interface 386 including a floor plan 404 of the physical space of the restaurant, populated with information from the virtual environment data 358. The floor plan 404 includes selectable regions corresponding to the key zones, including outside 460, lobby 462, main dining 464, bar 466, to go 468, and restrooms 470. The floor plan 404 may include graphical representations of the features and furnishings in the restaurant, and the location of the features and the placement of the furnishings in the restaurant, thereby providing an accurate representation of the target consumer environment. The selectable regions may be further delineated by lines or colors to further distinguish each region. Selection of a key zone in the selectable region will take the operator to a virtual representation of the key zone. By way of example, selection of the lobby 462 will present the lobby 502 screen on the display 382.

Referring to FIG. 5, an embodiment of the lobby 502 screen is shown. In an implementation, the textual material 384 represents information about the lobby key zone, including the strategic objectives 506, populated with information from the strategic objective data 362, business objectives 508 populated with information from the business objective data 364, and guest perspectives 510 populated with information from the guest perspective data 366. In an implementation, the graphical user interface 386 presents a virtual representation 504 of the lobby, populated with information from the virtual environment data 358. The virtual representation 504 of the key zone may be from the point of view of a target consumer, and shows the key markers of the key zone from the point of view of the consumer. An inset floor plan 518 provides selectable regions similar to the floor plan 404 above for showing the current key zone selected as well as allowing selection f and navigation to key zones.

The strategic objectives 506 and the business objectives 508 represent the objectives of the brand for the selected key zone, here the lobby. The guest perspectives 510 identify the selected participant's experience with the selected key zone, populated with information from the experience data 314 and summary report data 316. The objectives are specific to each key zone and articulate the purpose of each key zone as well as how it ties back into the overall brand experience. The objectives encourage proper execution of each marker in the consumer environment as well as serve as a form of training for the operator.

In an implementation, the lobby includes the markers currently used by a brand in the key zone, including a poster 522, a holder 524, and a display board. The markers appear to an operator in the visual representation 504 as they would to a consumer, including orientation, size, color, graphics, and text. A marker key 520 lists the markers available for the key zone. Selection of a marker displays textual material pertaining to the marker. For example, selection of the poster 522 displays selected marker information 512 for the poster 522, including the objectives 414 of the poster 522, populated by information from the marker data 368.

Referring to FIG. 6, an embodiment of main dining 602 screen is shown. In an implementation, the textual material 384 represents information about the main dining key zone, including the strategic objectives 606, populated with information from the strategic objective data 362, business objectives 608 populated with information from the business objective data 364, and guest perspectives 610 populated with information from the guest perspective data 366. In an implementation, the graphical user interface 386 presents a visual representation 604 of the main dining area, populated with information from the virtual environment data 358. The visual representation 604 may be from the point of view of a target consumer, and shows the key markers of the key zone from the point of view of the consumer. The graphical user interface includes an inset floor plan 618.

The strategic objectives 606 and the business objectives 608 represent the objectives of the brand for the selected key zone, here the main dining area pre meal. The guest perspectives 610 identify the selected participant's experience with the main dining area, populated with information from the experience data 314 and summary report data 316. The objectives are specific to the main dining area and articulate the purpose of the main dining area as well as how it ties back into the overall brand experience. The objectives encourage proper execution of each marker in the main dining area as well as serve as a form of training for the operator.

In an implementation, the main dining area includes the markers currently used by a brand in the main dining area, including a beverage or dessert menu 624, a menu insert 626, a table tent 628, a table cling 630, a caddy insert 632, and a check presenter.

The markers appear to the operator in the visual representation 604 as they would to a consumer, including orientation, size, color, graphics, and text. A marker key 620 lists the markers available for the main dining area. Selection of a marker displays textual material pertaining to the marker. For example, selection of the poster menu insert 626 displays selected marker information 612 for the menu insert 626, including the objectives 614 of the menu insert 626, populated by information from the marker data 368.

Each of the information, instructions, data, and applications identified herein can correspond to a set of instructions for performing one or more functions. These instructions need not be implemented as separate software programs, procedures, or modules. The device may include any number of processors, memory, input devices, output devices, storage devices, databases, displays, communication interfaces, network connections, networks, third party devices, or other peripherals. Further, various functions of the data processing device 380 may be implemented in hardware and software, including in one or more signal processing or application specific integrated circuits.

When interacting with the virtual consumer environment, the modeling system 202 includes a virtual logic system that provides additional functionality for the operator, including a warning that there are too many markers in a key zone and that the overabundance, type, or content of the markers would be too much for the consumer.

The modeling system 202 can output representations of the virtual consumer environment in various formats including a website or an interactive document file such as an interactive printable document format (PDF) file. The system 202 may be adapted to integrate and share data with complimentary software programs such as marker ordering and printing systems, and marker text and graphics development software.

In an embodiment, the operator of a restaurant retail establishment conducts consumer analysis to assess their consumers' experience with the restaurant brand in the restaurant consumer environment. In another embodiment, the operator of a restaurant retail establishment models the restaurant consumer experience to design, select, order, ship, and deploy markers in their consumer environment.

By way of example, the operator of one or more restaurant retail establishments selects markers currently used in the consumer experience modeling system 202, or created by the operator with the system 202, for manufacture and distribution to the restaurant retail establishments. The markers selected, manufactured, and distributed to the establishments may be identical, or the markers may be different. Some time may pass between when the operator orders the markers and when the markers arrive at their respective restaurant retail establishments. Upon receipt of the markers, the operator can access the system 202 to see how the markers are properly implemented in the consumer environment, including according to the relevant objectives. Thus, markers are placed in proper locations avoiding overcrowding, message dilution, and other adverse conditions.

The modeling system 202 allows an operator to assess the effectiveness of existing markers and make decisions regarding the development new markers before making an investment in the manufacture and distribution of existing or new markers. The operator can modify the existing markers in the virtual consumer environment, and can create and place new markers in the virtual consumer environment when experimenting with advertising campaigns. The operator can reference the strategic objectives, business objectives, and guest perspectives when developing concepts and content for the new markers. The modeling system 202 provides a method of standardizing the development, selection, manufacture, distribution, and execution of markers to best communicate the brand of a business. The system 202 allows an operator to select markers represented in the virtual consumer environment for manufacture and distribution to a corresponding retail consumer environment, and may be used to educate employees of the corresponding retail consumer environment as to the proper selection, arrangement, and location of markers.

According to an embodiment of the disclosed subject matter, a method of building a brand marketing kit includes selecting one or more markers for use in the consumer environment, wherein the markers are selected for manufacture and delivery from the interactive virtual representation of the consumer environment. The interactive virtual representation of the consumer environment may be provided by a computer program product operable to cause a data processing device to perform an operation of displaying the interactive virtual representation of the consumer environment and the markers on a display. The marketing kit may include one or more markers, including: signage; advertising material; sales material; menu; fixture; furnishing; article of clothing, such as an employee uniform; poster; object holder, such as a gift card holder; display board; beverage menu; dessert menu; menu insert; table tent; table cling; caddy insert; and check presenter. The markers may be viewed in the virtual representation of the consumer environment, moved in the virtual representation, and the text, colors, and graphics displayed by the markers may be modified prior to selecting the marker for manufacture and delivery to a consumer environment. One or more pre-existing markers presented in the virtual consumer environment may be designed to be used with other markers as a marketing kit. For example, the operator may need to replace multiple worn out or outdated markers for the main dining area. Markers used in the main dining area, including the main menu, the beverage menu, the dessert menu, the menu insert, the table cling, the caddy insert, and the check presenter may have a consistent look and feel because they are designed for use with a particular marketing campaign. Markers such as the beverage menu, the dessert menu, the table cling, and the caddy insert remain on each table, and would constitute a table marketing kit. Accordingly, the markers for use on the table marketing kit may be selected for manufacture or delivery as a marketing kit by the operator.

In use, an operator accesses the interactive virtual representation of the consumer environment using a data processing device. The operator may be a person associated with a consumer environment, such as a representative of a franchisee of a restaurant seeking replacement markers for their physical restaurant. The physical restaurant may represent a standardized layout of a franchisor's restaurant chain, and the virtual representation of the consumer environment may be a virtual representation of the standardized layout. The franchisor may have designed, selected, and arranged the virtual representation of the consumer environment, and the markers displayed therein. The operator views the consumer environment and the markers used in the consumer environment via a display. The operator may navigate through the virtual representation of the consumer environment and select a marketing kit for shipment to the operator's physical restaurant.

Having thus described the disclosed subject matter, what is claimed as new and desired to be secured by Letters Patent is:

1. A computer-implemented method of modeling a consumer experience, comprising the steps of:
receiving information representing a consumer environment by a programmed computer;
receiving information representing at least one marker of the consumer environment by the programmed computer; and
using the programmed computer to display the consumer environment and at least one marker on a display.

2. The method of claim 1, wherein information representing the consumer environment includes at least one key zone.

3. The method of claim 2, wherein information representing the at least one key zone is identified by a consumer.

4. The method of claim 1, wherein the display of the consumer environment includes an interactive virtual representation of the consumer environment.

5. The method of claim 4, wherein the virtual representation of the consumer environment includes at least one key zone.

6. The method of claim 4, wherein the display of the interactive virtual representation further includes the at least one marker including a text and a graphic.

7. The method of claim 6, further comprising:
selecting at least one marker; and
modifying the marker.

8. The method of claim 7, wherein modifying the marker comprises:
adding text or graphics;
removing text or graphics; and
moving the marker.

9. The method of claim 6, further comprising:
wherein information representing the consumer environment includes at least one key zone; and
wherein the at least one marker corresponds to the at least one key zone.

10. The method of claim 6, further comprising:
selecting the at least one marker for manufacturing; and
communicating the manufacturing information to a third party.

11. The method of claim 10, further comprising:
selecting the at least one marker for distribution; and
distributing the selected marker to at least one consumer environment.

12. The method of claim 4, further comprising:
preparing at least one new marker including a text and a graphic;
importing the at least one new marker into the interactive virtual representation of the consumer environment; and
displaying the at least one new marker on the display.

13. A marketing kit, comprising:
a first marker for use in a retail consumer environment;
wherein the first marker is selected for manufacture from an interactive virtual representation of a consumer environment provided by a computer program product operable to cause a data processing device to perform an operation of displaying the interactive virtual representation of the consumer environment and the first marker on a display.

14. The marketing kit of claim 13, wherein the first marker comprises a signage, an advertising material, a sales material, and a menu.

15. The marketing kit of claim 13, wherein the first marker comprises a fixture, a furnishing, an article of clothing, a poster, an object holder, a display board, beverage menu, a dessert menu, a menu insert, a table tent, a table cling, a caddy insert, and a check presenter.

16. The marketing kit of claim 13, wherein the computer program product is further operable to cause the data processing device to perform operations, comprising:
receiving data representing the consumer environment; and
receiving data representing the first marker of the consumer environment.

17. The marketing kit of claim 16, wherein the data representing the consumer environment includes at least one key zone.

18. The marketing kit of claim 17, wherein the data representing the at least one key zone is identified by a consumer.

19. The marketing kit of claim 13, wherein the interactive virtual representation of the consumer environment includes at least one key zone.

20. The marketing kit of claim 13, wherein the displaying of the interactive virtual representation further includes displaying the first marker including a text and a graphic.

21. The marketing kit of claim 20, wherein the computer program product is further operable to cause the data processing device to perform operations, comprising communicating information for the manufacture of the first marker to a third party.

22. The marketing kit of claim 21, wherein the computer program product is further operable to cause the data processing device to perform operations, comprising:
selecting the first marker for distribution; and
distributing the first marker to at least one retail consumer environment.

23. The marketing kit of claim 13, wherein the computer program product is further operable to cause the data processing device to perform operations, comprising modifying the first marker.

24. The marketing kit of claim 23, wherein modifying the first marker comprises:
adding text or graphics;
removing text or graphics; and
moving the first marker in the interactive virtual representation of the consumer environment.

25. The marketing kit of claim 13, wherein the computer program product is further operable to cause the data processing device to perform operations, comprising:
preparing at least one new marker including a text and a graphic;
importing the at least one new marker into the interactive virtual representation of the consumer environment; and
displaying the at least one new marker on the display.

26. The marketing it of claim 13, further comprising a plurality of markers.
